(19) United States
(12) Patent Application Publication
(10) Pub. No.: US 2025/0286317 A1
(43) Pub. Date: Sep. 11, 2025

(54) ELECTRIC CONNECTOR AND CABLE ASSEMBLY

(71) Applicant: BIZLINK INTERNATIONAL CORP., New Taipei City (TW)

(72) Inventors: Yanping ZHANG, New Taipei City (TW); Qixing XU, New Taipei City (TW); Haoran ZOU, New Taipei City (TW)

(21) Appl. No.: 18/597,812

(22) Filed: Mar. 6, 2024

(51) Int. Cl. H01R 13/629; H01R 13/627

(52) U.S. Cl. CPC H01R 13/62966; H01R 13/6273

(57) ABSTRACT

An electric connector includes a housing, a fixing seat and at least one latch. The housing includes a body. The body defines a space therein and has two outer surfaces opposite to each other. Each of the first outer surfaces has a platform and at least one pivot formed thereon. The fixing seat is disposed in the space and configured to mount some electrical terminals. The latch is pivotally connected with the pivots and configured to rotate relative to the body from a locking status to a releasing status through an intermediate status. Each latch is in close proximity to the platforms in the locking status, the releasing status and the intermediate status, thereby an outer edge of the latch being in contact with the platforms when the latch is on impact.

### BACKGROUND

### Technical Field

The present disclosure relates to electric connectors and cable assemblies respectively including one of these electric connectors. More particularly, the present disclosure relates to electric connectors and cable assemblies for power supply to servers.

### Description of Related Art

In the US patent U.S. Pat. No. 8,979,568B2, an electric connector 1 is disclosed. The electric connector 1 includes two locking bars 8. The locking bars 8 are connected with the bearing pivots 12 of the first housing half 2, such that the locking bars 8 can be rotated relative to the first housing half 2. However, the locking bars 8 are free from contact with any other portion of the first housing half 2. Therefore, when there is an impact to either one of the locking bars 8 in some status, the force born by this locking bar 8 will all be transferred to the bearing pivots 12 connected with this locking bar 8, leading to a high risk of fracture of the bearing pivots 12.

### SUMMARY

A technical aspect of the present disclosure is to provide an electric connector, which can effectively improve the durability.

According to an embodiment of the present disclosure, an electric connector includes a housing, a fixing seat and at least one latch. The housing includes a body. The body has two first outer surfaces opposite to each other. The body defines a space therein. Each of the first outer surfaces has a platform and at least one pivot formed thereon. The fixing seat is disposed in the space and configured to mount a plurality of electrical terminals. The latch is pivotally connected with the pivots and configured to rotate relative to the body from a locking status to a releasing status through an intermediate status. The latch is in close proximity to the platforms in the locking status, the releasing status and the intermediate status, thereby an outer edge of the latch being in contact with the platforms when the latch is on impact.

In one or more embodiments of the present disclosure, each of the platforms has a bottom abutting surface, a side abutting surface and a curved surface. The bottom abutting surface, the side abutting surface and the curved surface are respectively connected with a corresponding one of the first outer surfaces. The bottom abutting surface is connected with the side abutting surface via the curved surface. The latch is in close proximity to the curved surface in the locking status, the intermediate status and the releasing status.

In one or more embodiments of the present disclosure, the latch includes a handle and two baffles. The baffles are separated from each other and connected to two opposite ends of the handle. Each of the baffles has a first surface, a second surface, a third surface and a fourth surface. The first surface is opposite to the second surface and proximal to the body. The second surface is distal to the body. The third surface is perpendicularly connected with the first surface and defines a first groove for pivotally connecting with a corresponding one of the pivots. The fourth surface is away from the third surface and perpendicularly connected with the first surface. The fourth surface defines a second groove for snapping with the target connector.

In one or more embodiments of the present disclosure, the pivots extend along an axis. The latch rotates about the axis relative to the body. Each of the baffles further has a fifth surface and a sixth surface. The fifth surface is circularly curved around the axis and connected between the first surface and the second surface. The sixth surface is tangentially connected with the fifth surface and connected between the first surface and the second surface. The sixth surface is flat. The fifth surface is in close proximity to the curved surface of a corresponding one of the platforms in the locking status, the releasing status and the intermediate status, while the sixth surface is in close proximity to the bottom abutting surface of the corresponding one of the platforms in the releasing status.

In one or more embodiments of the present disclosure, the axis defines a perpendicular distance from the platforms. Each of the fifth surfaces has a radius relative to the axis. The radius is equal to the perpendicular distance.

In one or more embodiments of the present disclosure, a profile of each of the curved surfaces and a corresponding one of the bottom abutting surfaces matches with a profile of the fifth surface and the sixth surface of a corresponding one of the baffles.

In one or more embodiments of the present disclosure, each of the curved surfaces is circularly curved around the axis.

In one or more embodiments of the present disclosure, each of the baffles further has a seventh surface. The seventh surface is curved and connected between the first surface and the second surface. The sixth surface is connected between the fifth surface and the seventh surface. The seventh surface is configured to abut against a corresponding one of the bottom abutting surfaces. The profile of each of the bottom abutting surfaces further matches with a profile of the seventh surface of a corresponding one of the baffles.

In one or more embodiments of the present disclosure, each of the platforms has a second outer surface away from the body. Each of the bottom abutting surfaces, a corresponding one of the curved surfaces and a corresponding one of the side abutting surfaces are connected between a corresponding one of the first outer surfaces and a corresponding one of the second outer surfaces. Each of the platforms further has a plurality of holes. The holes are distributed on the second outer surface.

In one or more embodiments of the present disclosure, each of the third surfaces is at least partially curved circularly around the axis.

In one or more embodiments of the present disclosure, each of the pivots is a cylindrical column.

In one or more embodiments of the present disclosure, the baffles are structurally symmetrical with each other.

In one or more embodiments of the present disclosure, the handle and the baffles are one piece formed.

In one or more embodiments of the present disclosure, the body, the platforms and the pivots are one piece formed.

In one or more embodiments of the present disclosure, a quantity of the latch is two. The latches are structurally symmetrical with each other.

According to an embodiment of the present disclosure, an electric connector includes a housing and a latch. The housing has a front surface and a back surface. The front surface has a first pivot and a protrusion formed thereon. The back surface has a second pivot aligned with the first pivot. The latch is pivotally connected with the first pivot and the second pivot. The latch is configured to rotate relative to the housing from a locking status to a releasing status through an intermediate status. The latch is in close proximity to the protrusion in the locking status, the intermediate status and the releasing status, thereby an outer contour of the latch being in contact with the protrusion when the latch is on impact in either one of the locking status, the releasing status and the intermediate status.

In one or more embodiments of the present disclosure, the protrusion has a bottom abutting surface, a side abutting surface and a curved surface connected between the bottom abutting surface and the side abutting surface. The bottom abutting surface is substantially perpendicular to the side abutting surface. When the latch is in the locking status, an outer contour of the latch is in contact with the side abutting surface. When the latch is in the releasing status, the outer contour of the latch is in contact with the bottom abutting surface. When the latch is in the intermediate status, the outer contour of the latch is away from the side abutting surface and the bottom abutting surface.

A technical aspect of the present disclosure is to provide a cable assembly, which can effectively improve the durability.

According to an embodiment of the present disclosure, a cable assembly includes a cable and one of the electric connectors mentioned above. The electric connector is electrically connected with an end of the cable.

The above-mentioned embodiments of the present disclosure have at least the following advantages: since the baffles of each of the latches are in close proximity to the platforms in all the locking status, the releasing status and the intermediate status, when there is an impact to either one of the latches in either one of the locking status, the releasing status or the intermediate status, the force born by the latch will be transferred not only to the pivots of the housing but also to the platforms through the curved surfaces (and the bottom abutting surfaces or the side abutting surface, depending on the status of this latch at the moment of impact and the angle of the force exerting on this latch). In this way, the force exerting on the pivots in an impact to the latch will be effectively reduced, and the risk of fracture of the pivots is greatly reduced. Therefore, the durability of the electric connector is effectively improved.

### BRIEF DESCRIPTION OF THE DRAWINGS

The disclosure can be more fully understood by reading the following detailed description of the embodiments, with reference made to the accompanying drawings as follows:

FIG. 1 is a schematic view of an electric connector according to an embodiment of the present disclosure;

FIG. 2 is an exploded view of the electric connector of FIG. 1;

FIG. 3 is a side view of the electric connector of FIG. 1;

FIG. 4 is a front view of the housing of FIG. 1;

FIG. 5 is a sectional view along the sectional line B-B of FIG. 2;

FIG. 6 is a schematic view of one of the latches of FIG. 1;

FIG. 7 is a sectional view along the sectional line A-A of FIG. 1;

FIG. 8 is a front view of the electric connector of FIG. 1, in which the latches are in the locking status;

FIG. 9 is a front view of the electric connector of FIG. 1, in which the latches are in the releasing status; and

FIG. 10 is a front view of the electric connector of FIG. 1, in which the latches are in the intermediate status.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

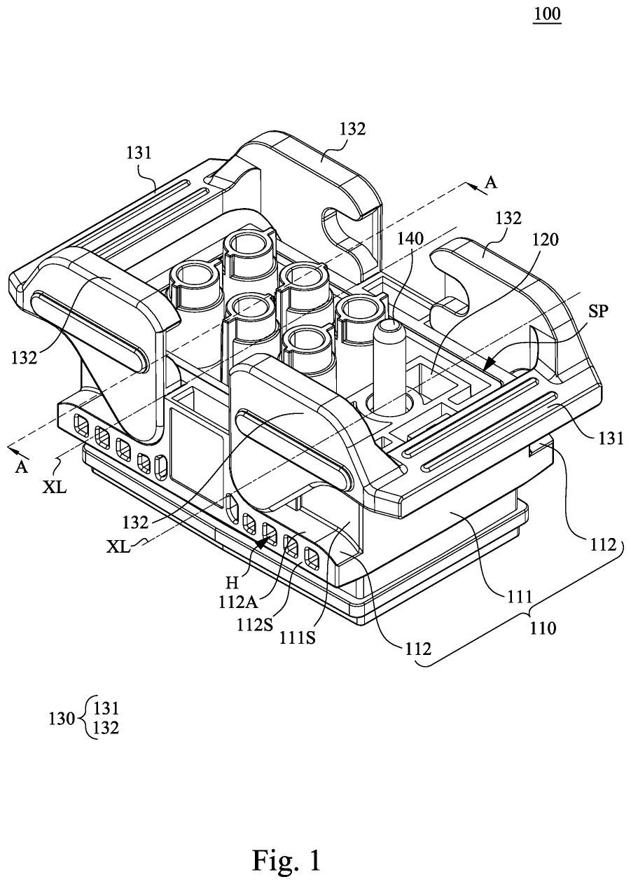

FIGS. 1-10 are drawn according to the actual scale. For the sake of concise description in this specification, the scales of the elements are not listed one by one. However, the scale and position of each element should be regarded as part of the scope of this specification.

Furthermore, if the description in this specification is insufficient to explain the detailed design of the elements and makes it uneasy to implement, please take the electrical plug-in connector disclosed in the U.S. Pat. No. 8,979,568B2 as a reference.

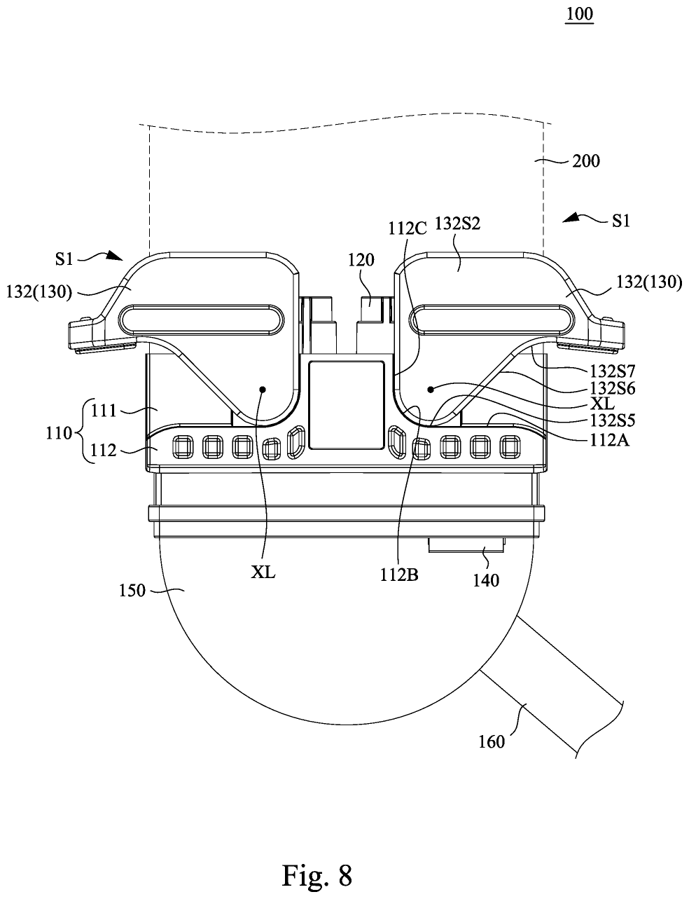

As shown in FIGS. 1-10, a cable assembly with an electric connector 100, two of which are connected at both ends of a cable 160 respectively, is provided in the present disclosure. Only one end of the cable assembly is showed for clarity consideration. Moreover, for example, the electric connector 100 is applied to connect with a target connector 200 (please see FIGS. 8-10 for the target connector 200) of a server for the sake of high current power supply.

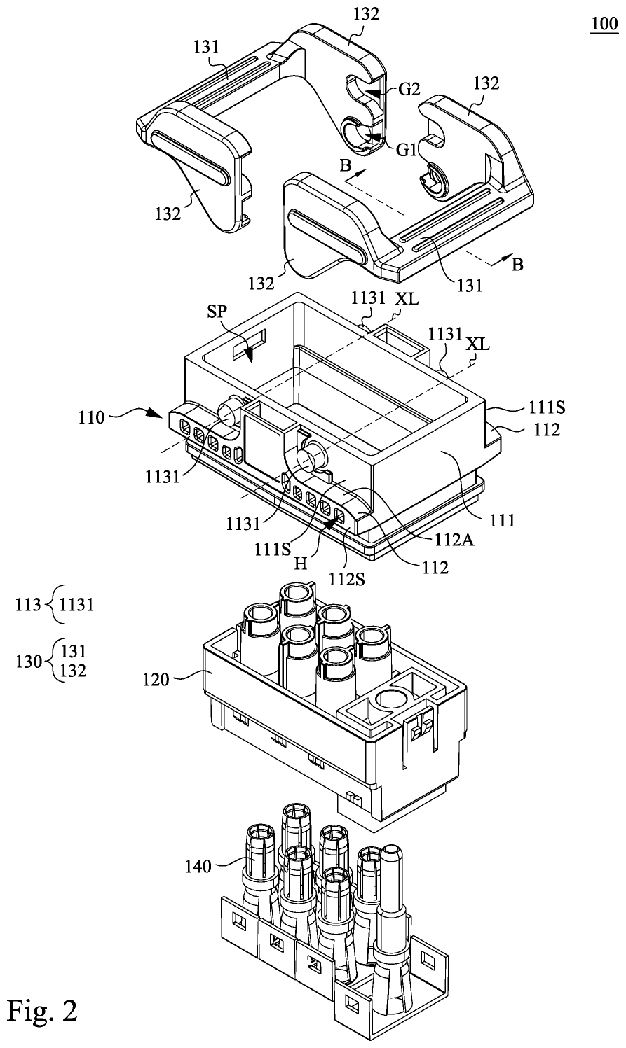

FIG. 1 is a schematic view of an electric connector 100 according to an embodiment of the present disclosure. FIG. 2 is an exploded view of the electric connector 100 of FIG. 1. In this embodiment, as shown in FIGS. 1-2, the electric connector 100 includes a housing 110, a fixing seat 120, two latches 130, a plurality of electrical terminals 140 and a molding piece 150 (please see FIGS. 8-10 for the molding piece 150). The latches 130 are structurally symmetrical with each other.

In this embodiment, the electric connector 100 is a plug end connector with a cable 160 connected therewith. However, while the electric connector 100 is a socket end connector without cable connected therewith, the molding piece 150 and the cable 160 might be omitted.

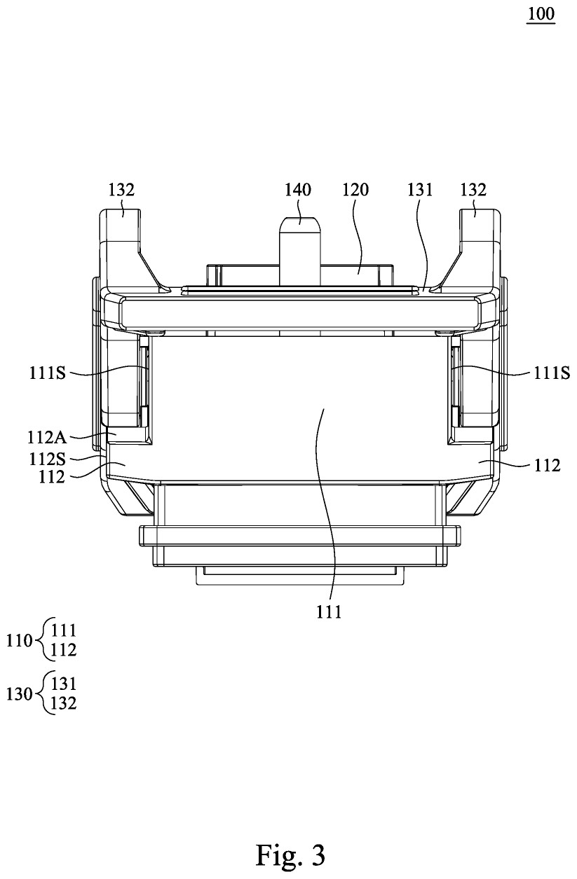

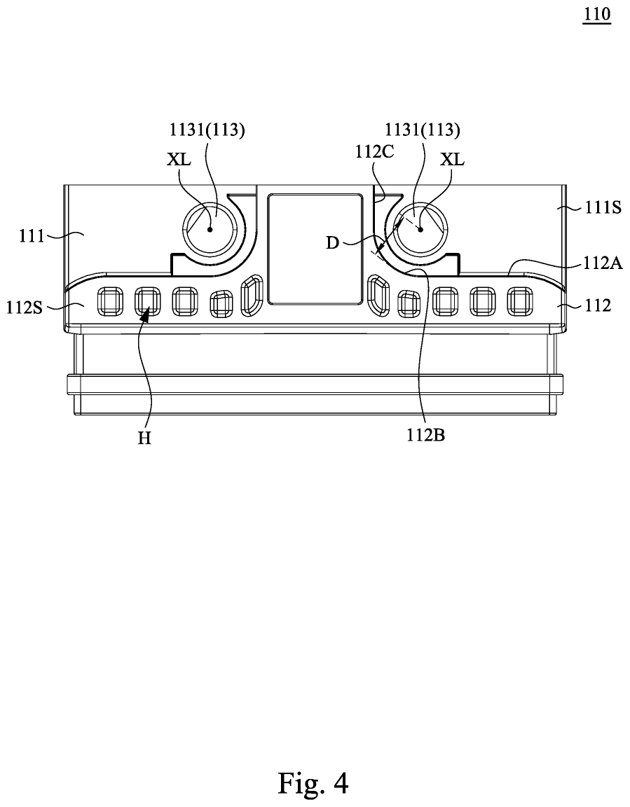

FIG. 3 is a side view of the electric connector 100 of FIG. 1. FIG. 4 is a front view of the housing 110 of FIG. 1. As shown in FIGS. 1-4, the housing 110 includes a body 111, two platforms 112 and two pivot sets 113.

The body 111 is hollow-shaped and has two first outer surfaces 111S opposite to each other. The body 111 defines a space SP therein.

Both of the platforms 112 are respectively disposed on a corresponding one of the first outer surfaces 111S. Both of the pivot sets 113 are disposed on the first outer surfaces 111S along two axes XL separated from each other in a parallel manner. All of the body 111, the platforms 112 and the pivot sets 113 are one piece formed of insulating material by injection molding process.

Furthermore, as shown in FIG. 2, each of the pivot sets 113 includes two pivots 1131. The pivots 1131 are separated from each other and disposed on the first outer surfaces 111S along a corresponding one of the axes XL. In this embodiment, for example, each of the pivots 1131 is substantially cylindrical-shaped column.

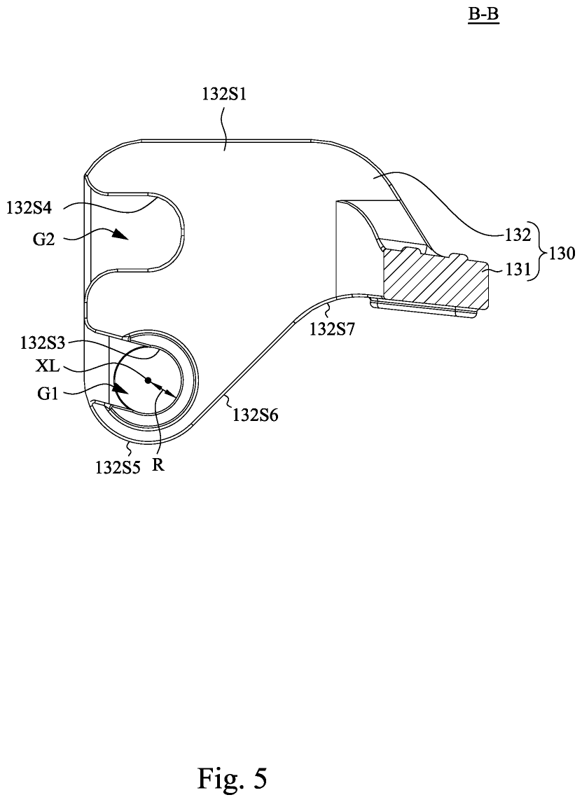

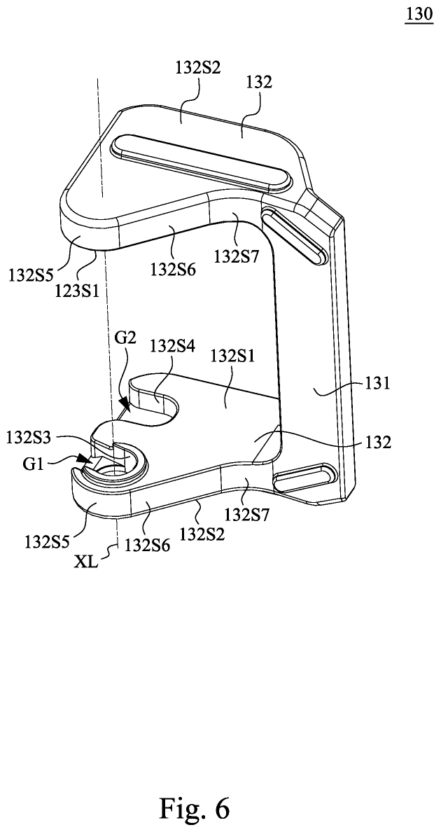

FIG. 5 is a sectional view along the sectional line B-B of FIG. 2. FIG. 6 is a schematic view of one of the latches 130 of FIG. 1. As shown in FIGS. 1-3 and 5-6, each of the latches 130 includes a handle 131 and two baffles 132. The baffles 132 are separated from each other and connected to two opposite ends of the handle 131. The baffles 132 are structurally symmetrical with each other. The handle 131 and the baffles 132 are one piece formed. Each of the baffles 132 has a first surface 132S1, a second surface 132S2, a third surface 132S3, a fourth surface 132S4, a fifth surface 132S5, a sixth surface 132S6 and a seventh surface 132S7.

As shown in FIGS. 1-3 and 5-6, the first surface 132S1 is opposite to the second surface 132S2 and proximal to the body 111 of the housing 110. The second surface 132S2 is distal to the body 111 of the housing 110. The third surface 132S3 of each of the baffles 132 is perpendicularly connected with the first surface 132S1 and defines a first groove G1. In other words, the first groove G1 is located on the first surface 132S1. Furthermore, each of the third surfaces 132S3 is at least partially curved circularly around a corresponding one of the axes XL, such that the first groove G1 is at least partially circular in shape. The fourth surface 132S4 is away from the third surface 132S3 and perpendicularly connected with the first surface 132S1. The fourth surface 132S4 defines a second groove G2. In other words, the second groove G2 is also located on the first surface 132S1 but is separated from the first groove G1.

Furthermore, as shown in FIGS. 5-6, the fifth surface 132S5 is circularly curved around the axis XL and connected between the first surface 132S1 and the second surface 132S2. The sixth surface 132S6 is tangentially connected with the fifth surface 132S5 and connected between the first surface 132S1 and the second surface 132S2. In this embodiment, the sixth surface 132S6 is a flat surface.

On the other hand, as shown in FIG. 4, each of the axes XL defines a perpendicular distance D from the platforms 112. Furthermore, as shown in FIGS. 1-4, each of the platforms 112 is T-shaped. Each of the platforms 112 has a bottom abutting surface 112A, a side abutting surface 112C and a curved surface 112B respectively on both of the two sides of the T-shaped structure. Each of the bottom abutting surfaces 112A connects with a corresponding one of the side abutting surfaces 112C via a corresponding one of the curved surfaces 112B. Each of the bottom abutting surfaces 112A is substantially perpendicular to a corresponding one of the side abutting surface 112C.

Each of the bottom abutting surfaces 112A is respectively connected with a corresponding one of the first outer surfaces 111S. To be specific, as shown in FIG. 4, each of the axes XL defines the perpendicular distance D from the corresponding one of the curved surfaces 112B of each of the platforms 112. Correspondingly, as shown in FIG. 5, each of the fifth surfaces 132S5 has a radius R relative to a corresponding one of the axes XL. In this embodiment, the radius R is substantially equal to the perpendicular distance D.

In addition, as shown in FIGS. 5-6, the seventh surface 132S7 is curved and connected between the first surface 132S1 and the second surface 132S2. The sixth surface 132S6 is connected between the fifth surface 132S5 and the seventh surface 132S7. It is worth to note that, in this embodiment, a profile of each of the bottom abutting surfaces 112A and a corresponding one of the curved surfaces 112B matches with a profile of the fifth surface 132S5, the sixth surface 132S6 and the seventh surface 132S7 of a corresponding one of the baffles 132. To be specific, each of the curved surfaces 112B is circularly curved around a corresponding one of the axes XL.

As shown in FIGS. 1-2 and 4, each of the platforms 112 has a second outer surface 112S away from the body 111. Each of the bottom abutting surfaces 112A, a corresponding one of the curved surfaces 112B and a corresponding one of the side abutting surfaces 112B are connected between a corresponding one of the first outer surfaces 111S and a corresponding one of the second outer surfaces 112S. Each of the platforms 112 further has a plurality of holes H. The holes H are distributed on the second outer surface 112S.

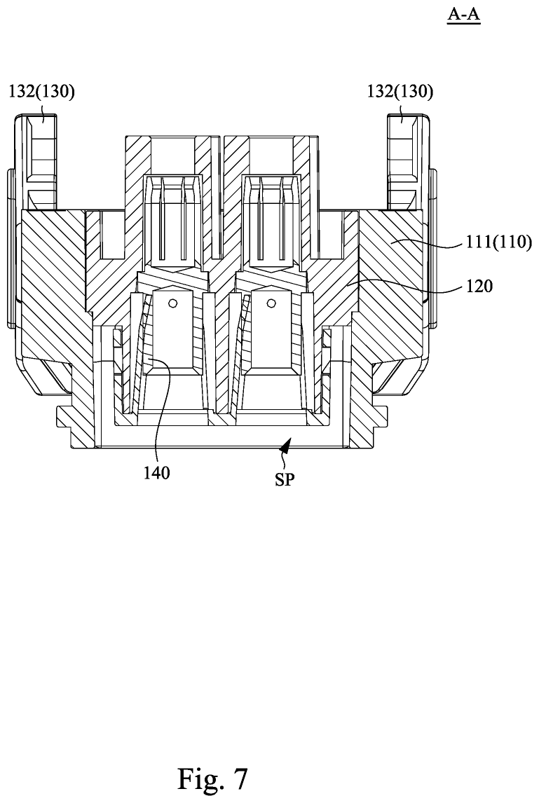

FIG. 7 is a sectional view along the sectional line A-A of FIG. 1. The fixing seat 120 is disposed in the space SP of the body 111 and configured to mount the electrical terminals 140.

FIG. 8 is a front view of the electric connector 100 of FIG. 1, in which the latches 130 are in the locking status S1. As shown in FIG. 1 and FIG. 8, each of the latches 130 is pivotally connected with a corresponding one of the pivot sets 113 (please refer to FIG. 2 and FIG. 4 for the pivot sets 113) and configured to rotate relative to the body 111 of the housing 110 about a corresponding one of the axes XL. To be specific, each of the pivots 1131 of the housing 110 is pivotally accommodated in a corresponding one of the first grooves G1 (please see FIG. 2 and FIGS. 5-6 for the first grooves G1). In other words, the first groove G1 on each of the baffles 132 is pivotally connected with a corresponding one of the pivots 1131 (please see FIG. 2 and FIG. 4 for the pivots 1131). Moreover, as shown in FIG. 8, both of the latches 130 are in the locking status S1, in which the latches 130 are rotated towards each other for engaging with a target connector 200 (presented in hidden lines). Meanwhile, the electric connector 100 is connected with a connecting cable 160 (presented in hidden lines), such that the electric connector 100 is connected between the target connector 200 and the connecting cable 160. Furthermore, to be specific, the second groove G2 on each of the baffles 132 is snapped with a corresponding one of the pivots (not shown) of the target connector 200, such that the target connector 200 is connected to the electric connector 100 in a secured manner. It is worth to note that, in this embodiment, the curved surfaces 112B are respectively configured to abut against a corresponding one of the baffles 132. To be specific, the fifth surface 132S5 of each of the baffles 132 is in close proximity to a corresponding one of the curved surfaces 112B in the locking status S1.

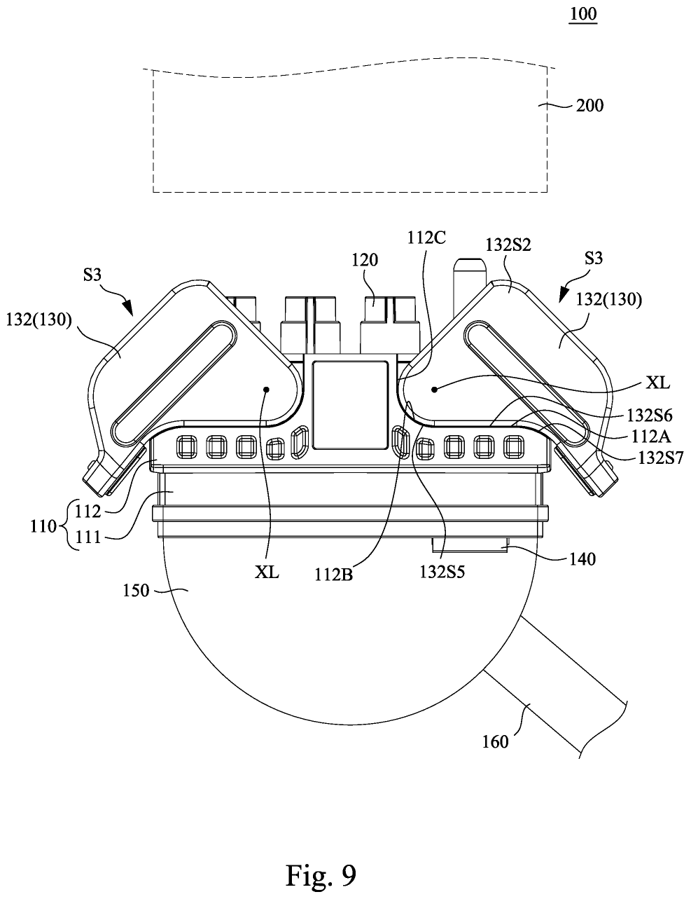

FIG. 9 is a front view of the electric connector 100 of FIG. 1, in which the latches 130 are in the releasing status S2. In this embodiment, as shown in FIG. 9, both of the latches 130 are respectively rotated from the locking status S1 to the releasing status S2 relative to the housing 110 about a corresponding one of the axes XL. To be specific, in the releasing status S2, the latches 130 are rotated away from each other, such that the electric connector 100 can be released from the target connector 200. It is worth to note that, in this embodiment, each of the fifth surfaces 132S5 and the adjacent ones of the sixth surface 132S6 and seventh surface 132S7 are in close proximity to a corresponding one of the bottom abutting surfaces 112A and a corresponding one of the curved surfaces 112B in the releasing status S2.

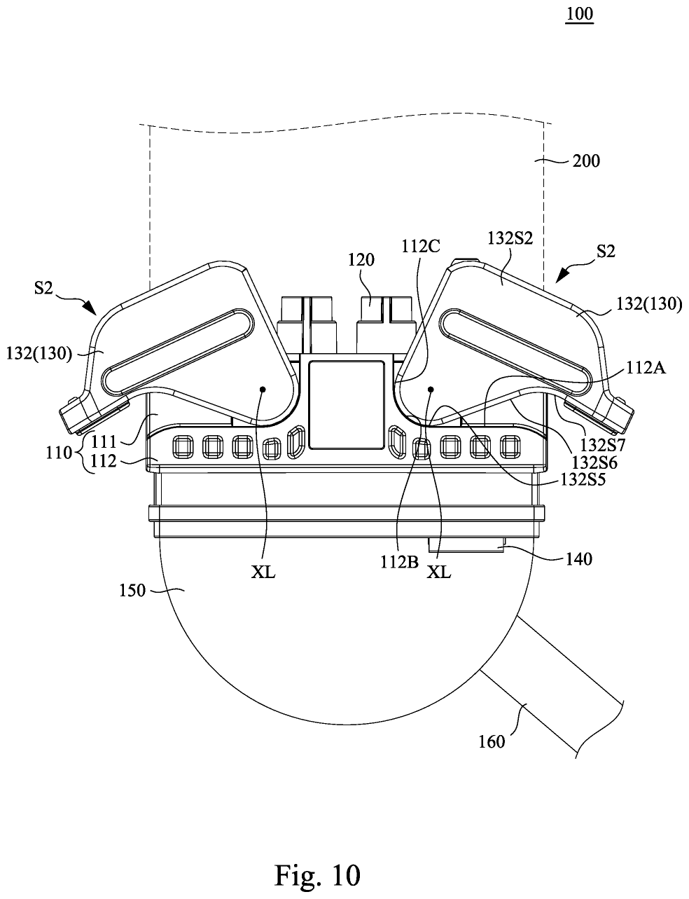

FIG. 10 is a front view of the electric connector 100 of FIG. 1, in which the latches 130 are in the intermediate status S3. In this embodiment, as shown in FIG. 10, both of the latches 130 are respectively further rotated from the releasing status S2 to the intermediate status S3 relative to the housing 110 about a corresponding one of the axes XL. It is worth to note that, in this embodiment, each of the fifth surfaces 132S5 is still in close proximity to a corresponding one of the curved surfaces 112B in the releasing status S2. Moreover, in the intermediate status S3, the outer contour of each of the latches 130 is away from the side abutting surface 112C and the bottom abutting surface 112A.

It is important to clarify that, each of the latches 130 may, but not necessarily, be always in contact and interfering with the platforms 120. Instead, in the normal operational states of the latches and pivots, there can optionally be a small gap due to tolerances or design between the each of the latches 130 and the platforms 120, while the said gap has to be smaller than or equal to the sum of the maximum movable range of the latch 130 on impact, the maximum elastic deformation of this latch 130, and the maximum elastic deformation of the pivot 1131. Moreover, as an example, the said gap is typically not greater than one-fifth of the diameter of the pivot 1131. More specifically, the said gap is suggested to be smaller than 500 micrometer and is preferably smaller than 150 micrometers. By the said design, when the connector 100 is dropped from a height, for example, of one meter and one of the latches 130 is impacted by the floor, this latch 130, due to displacement, deformation or any other matters, will be in contact with the platforms 120 no matter the connector 100 is in either one of the locking status, the intermediate status and the locking status before the corresponding pivots 1131 undergo irreversible plastic deformation/destruction, thus avoiding the pivots 1131 from being damaged or at least reducing the extent of damage to the pivots 1131.

As mentioned above, since the baffles 132 of each of the latches 130 are in close proximity to the platforms 112 in all the locking status S1, the releasing status S2 and the intermediate status S3, when there is an impact to either one of the latches 130 in either one of the locking status S1, the releasing status S2 or the intermediate status S3, the force born by the latch 130 will be transferred not only to the pivots 1131 of the housing 110 but also to the platforms 112 through the curved surfaces 112B (and the bottom abutting surfaces 112A or the side abutting surfaces 112C, depending on the status of this latch 130 at the moment of impact and the angle of the force exerting on this latch 130). In this way, the force exerting on the pivots 1131 in an impact to the latch 130 will be effectively reduced, and the risk of fracture of the pivots 1131 is greatly reduced. Therefore, the durability of the electric connector 100 is effectively improved.

In conclusion, the aforementioned embodiments of the present disclosure have at least the following advantages: since the baffles of each of the latches are in close proximity to the platforms in all the locking status, the locking status and the intermediate status, when there is an impact to either one of the latches in either one of the locking status, the locking status or the intermediate status, the force born by the latch will be transferred not only to the pivots of the housing but also to the platforms through the curved surfaces (and the bottom abutting surfaces or the side abutting surface, depending on the status of this latch at the moment of impact and the angle of the force exerting on this latch). In this way, the force exerting on the pivots in an impact to the latch will be effectively reduced, and the risk of fracture of the pivots is greatly reduced. Therefore, the durability of the electric connector is effectively improved.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An electric connector, comprising:
a housing comprising a body, the body having two first outer surfaces opposite to each other, the body defining a space therein, each of the first outer surfaces having a platform and at least one pivot formed thereon;
a fixing seat disposed in the space and configured to mount a plurality of electrical terminals; and
at least one latch pivotally connecting with the pivots and configured to rotate relative to the body from a locking status to a releasing status through an intermediate status,
wherein the latch is in close proximity to the platforms in the locking status, the intermediate status and the releasing status, thereby an outer edge of the latch being in contact with the platforms when the latch is on impact.

2. The electric connector of claim 1, wherein each of the platforms has a bottom abutting surface, a side abutting surface and a curved surface, the bottom abutting surface, the side abutting surface and the curved surface are respectively connected with a corresponding one of the first outer surfaces, the bottom abutting surface is connected with the side abutting surface via the curved surface, the latch is in close proximity to the curved surface in the locking status, the intermediate status and the releasing status.

3. The electric connector of claim 2, wherein the latch comprises:
a handle; and
two baffles separated from each other and connected to two opposite ends of the handle, each of the baffles has a first surface, a second surface, a third surface and a fourth surface, the first surface is opposite to the second surface and proximal to the body, the second surface is distal to the body, the third surface is perpendicularly connected with the first surface and defines a first groove for pivotally connecting with a corresponding one of the pivots, the fourth surface is away from the third surface and perpendicularly connected with the first surface, the fourth surface defines a second groove for snapping with a target connector.

4. The electric connector of claim 3, wherein the pivots extend along an axis, the latch rotates about the axis relative to the body, each of the baffles further has a fifth surface and a sixth surface, the fifth surface is circularly curved around the axis and connected between the first surface and the second surface, the sixth surface is tangentially connected with the fifth surface and connected between the first surface and the second surface, the sixth surface is flat,
wherein the fifth surface is in close proximity to the curved surface of a corresponding one of the platforms in the locking status, the releasing status and the intermediate status, while the sixth surface is in close proximity to the bottom abutting surface of the corresponding one of the platforms in the releasing status.

5. The electric connector of claim 4, wherein the axis defines a perpendicular distance from the platforms, each of the fifth surfaces has a radius relative to the axis, the radius is substantially equal to the perpendicular distance.

6. The electric connector of claim 4, wherein a profile of each of the curved surfaces and a corresponding one of the bottom abutting surfaces matches with a profile of the fifth surface and the sixth surface of a corresponding one of the baffles.

7. The electric connector of claim 6, wherein each of the curved surfaces is circularly curved around the axis.

8. The electric connector of claim 6, wherein each of the baffles further has a seventh surface, the seventh surface is curved and connected between the first surface and the second surface, the sixth surface is connected between the fifth surface and the seventh surface, the seventh surface is configured to abut against a corresponding one of the bottom abutting surfaces, the profile of each of the bottom abutting surfaces further matches with a profile of the seventh surface of a corresponding one of the baffles.

9. The electric connector of claim 6, wherein each of the platforms has a second outer surface away from the body, each of the bottom abutting surfaces, a corresponding one of the curved surfaces and a corresponding one of the side abutting surfaces are connected between a corresponding one of the first outer surfaces and a corresponding one of the second outer surfaces, each of the platforms further has a plurality of holes distributed on the second outer surface.

10. The electric connector of claim 3, wherein each of the third surfaces is at least partially curved circularly around the axis.

11. The electric connector of claim 10, wherein each of the pivots is a cylindrical column.

12. The electric connector of claim 3, wherein the baffles are structurally symmetrical with each other.

13. The electric connector of claim 3, wherein the handle and the baffles are one piece formed.

14. The electric connector of claim 1, wherein the body, the platforms and the pivots are one piece formed.

15. The electric connector of claim 1, wherein a quantity of the latch is two, the latches are structurally symmetrical with each other.

16. An electric connector, comprising:
a housing having a front surface and a back surface, the front surface having a first pivot and a protrusion formed thereon, the back surface having a second pivot aligned with the first pivot; and
a latch pivotally connected with the first pivot and the second pivot, the latch being configured to rotate relative to the housing from a locking status to a releasing status through an intermediate status,
wherein, the latch is in close proximity to the protrusion in the locking status, the intermediate status and the releasing status, thereby an outer contour of the latch being in contact with the protrusion when the latch is on impact in either one of the locking status, the releasing status and the intermediate status.

17. The electric connector of claim 16, wherein the protrusion has a bottom abutting surface, a side abutting surface and a curved surface connected between the bottom abutting surface and the side abutting surface, the bottom abutting surface is substantially perpendicular to the side abutting surface,
wherein, when the latch is in the locking status, an outer contour of the latch is in contact with the side abutting surface, when the latch is in the releasing status, the outer contour of the latch is in contact with the bottom abutting surface, when the latch is in the intermediate status, the outer contour of the latch is away from the side abutting surface and the bottom abutting surface.

18. A cable assembly, comprising:
a cable; and
the electric connector of claim 16, the electric connector being electrically connected with an end of the cable.
